(19) United States
(12) Patent Application Publication
(10) Pub. No.: US 2013/0019754 A1
(43) Pub. Date: Jan. 24, 2013

(54) BREWING DEVICE WITH LEAK-PROOF STRUCTURE

(71) Applicants: PAO-WU TIEN, Taipei City (TW); Yu-Mei Tien Lin, Taipei City (TW)

(72) Inventors: PAO-WU TIEN, Taipei City (TW); Yu-Mei Tien Lin, Taipei City (TW)

(21) Appl. No.: 13/188,469

(22) Filed: Jul. 22, 2011

(51) Int. Cl. A47J 31/44

(52) U.S. Cl. 99/279

(57) ABSTRACT

A brewing device includes a receptacle, which has a bottom forming a bore. A filtering member is received in the receptacle. A flow control assembly is arranged below the receptacle and is vertically movable with respect to the receptacle. The flow control assembly includes a bar extendible through the bore. An upward movement of the flow control assembly pushes away a closure member sitting on the bore. A guidance section is formed below the bore. The flow control assembly includes a flow guide section corresponding to the guidance section. When the flow control assembly is moved upward, the guidance section and the flow guide section collectively form a water passage. A brewing liquid contained in the receptacle, when discharged through the bore, is shielded by the water passage and is confined and concentrated for smooth flow thereby eliminate the occurrence of leak, splash, and overflow of the brewing liquid.

### TECHNICAL FIELD OF THE INVENTION

The present invention generally relates to a brewing device, and more particularly to a brewing device with leak-proof structure that effectively shields, confines, and concentrates brewing liquid and guide smooth drainage of the liquid so as to eliminate undesired leakage, outward splashing, and overflowing of the brewing liquid.

### DESCRIPTION OF THE PRIOR ART

Taiwan Utility Model M363267 discloses a structure that comprises a flask forming a through hole and a flow control member and a filtering screen arranged inside the flask, and a flow stop control assembly that is arranged under the flask and vertically movable. When a substance to be brewed has been soaked in liquid contained in the flask for a predetermined period of time, the flask is moved to above a container. The container is then moved upward to push up the flow stop control assembly, making a peg of the flow stop control assembly pushing the flow control member that is positioned on and blocks the through hole upwards to be separated from the through hole. Consequently, the brewing liquid contained in the flask is allowed to flow through the through hole and then pass through a through hole defined in the flow stop control assembly to dispense into the container to be drunk.

Practicing the Utility Model reveals that the device of the Utility Model has certain severe drawbacks. The brewing liquid, when flowing through the through hole, is moving in a fast speed and is also expanding. The high speed flow forcibly impinges ribs and bars structurally arranged inside the through hole and strikes an upper surface of he flow stop control assembly, leading to splashing of the liquid. Further, the through hole defined in the flow stop control assembly is not of a sufficient size to timely drain or discharge the brewing liquid passing through the through hole of the flask, leading to the liquid overflowing the flask to enter a space between the bottom of the flask and the upper surface of the flow stop control assembly. This may result in further leakage of the liquid through gaps between components/parts or further overflow and eventually being splashed on and contaminating a tabletop.

Briefly speaking, the major cause for such drawbacks of the known device is that when the brewing liquid that fast passes through the hole of the flask for draining flows through passages or space between the bottom of the flask and the upper surface of the flow stop control assembly, no means is provided for shielding and guiding the flow. Further, due to the physical property of the discharged flow that shows an uncertain direction of flow and provides a strong power of penetration, the brewing liquid, when discharged from the hole of the flask, may result in a random flow, expansion, impacting, and penetration, and eventually causing leaking, splashing, and overflow. This is certainly impractical.

In view of the above discussed problems, the present invention aims to provide a brewing device that overcomes such problems.

### SUMMARY OF THE INVENTION

An objective of the present invention is to provide a brewing device with a leak-proof structure that eliminates the occurrence of leak, splash, and overflow of a brewing liquid.

To achieve the above objective, the present invention provides a brewing device that comprises a receptacle, a filtering member, and a flow control assembly. The receptacle has a bottom forming a bore. The filtering member is received in the receptacle. The flow control assembly is arranged below the receptacle and is vertically movable with respect to the receptacle. The flow control assembly comprises a bar that is extendible through the bore. An upward movement of the flow control assembly pushes away a closure member sitting on the bore. A guidance section is formed below and extends downward from the bore. The flow control assembly comprises a flow guide section corresponding to the guidance section. When the flow control assembly is moved upward, the guidance section and the flow guide section collectively form a water passage. The brewing liquid contained in the receptacle, when discharged through the bore, is shielded by the water passage and is confined and concentrated for smooth flow thereby eliminate the occurrence of leak, splash, and overflow of the brewing liquid.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of the present invention.

FIG. 2 is an exploded view of the present invention.

FIG. 2A is a partial enlarged view of FIG. 2.

FIG. 3 is a cross-sectional view of the present invention in a flow stopped condition.

FIG. 3A is a partial enlarged view of FIG. 3.

FIG. 4 is a cross-sectional view of the present invention in a flow discharged condition.

FIG. 4A is a partial enlarged view of FIG. 4.

FIG. 5 is a cross-sectional view of the present invention when placed on a table top.

FIG. 6 is a perspective view illustrating the present invention used with a container having an outside diameter greater than a flow control assembly to allow liquid contained in a receptacle to be discharged into the container.

FIG. 7 is a perspective view, partially broken, showing another embodiment of a flow control assembly according to the present invention.

FIG. 8 is a cross-sectional view of the flow control assembly of said another embodiment of the present invention.

FIG. 9 is a cross-sectional view illustrating use of the flow control assembly according to said another embodiment of the present invention.

FIG. 9A is a partial enlarged view of FIG. 9.

FIG. 10 is a perspective view showing a lid is pivotally connected to a receptacle according to the present invention.

FIG. 11 is a perspective view illustrating another embodiment of a chassis according to the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

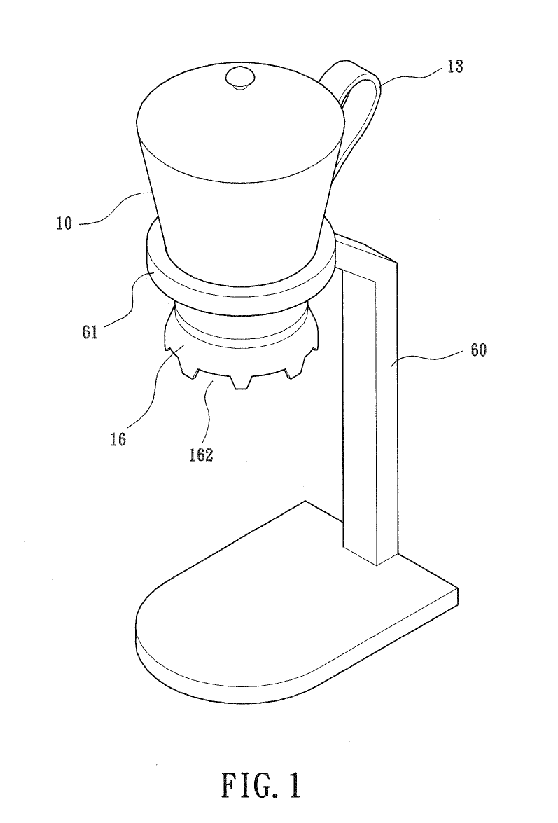

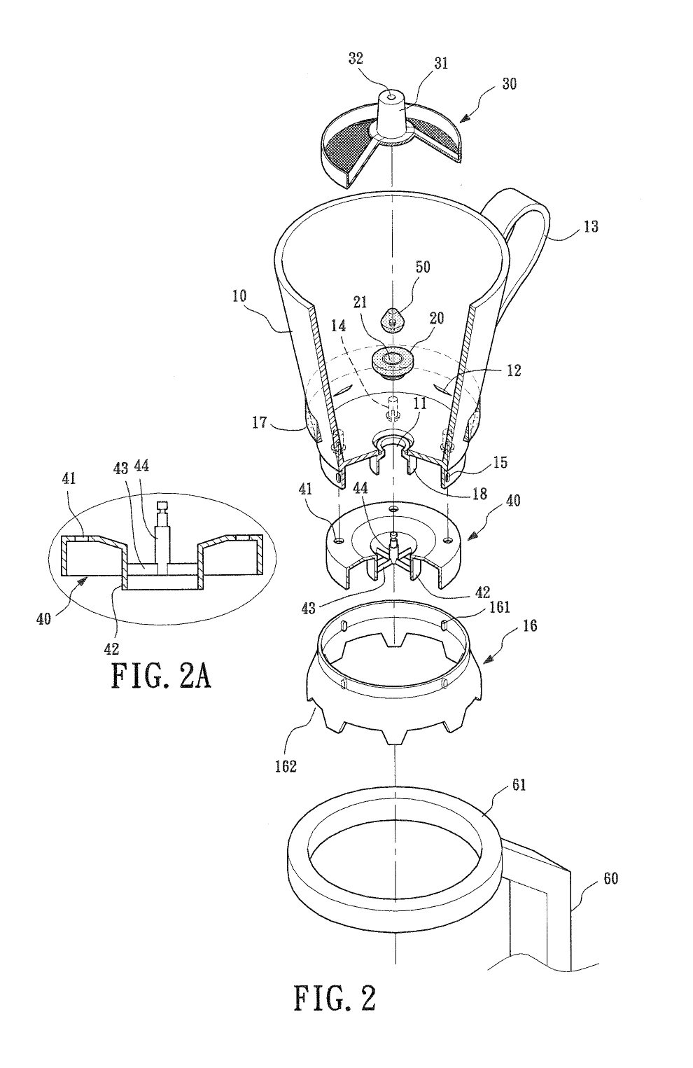

Referring to FIGS. 1, 2, 2A, 3 and 3A, the present invention comprises a receptacle 10, a bearing member 20, a filtering member 30, a flow control assembly 40, a closure member 50, and a chassis 60. They will be described in detail as follows.

The receptacle 10 may receive therein coffee powders, tea leaves, or other substance to be brewed and has a bottom forming a bore 11. The bottom of the receptacle 10 is structured to show a predetermined slope so as to effectively draw a brewing liquid toward the bore 11. Arranged above the bore 11 is the bearing member 20, which is made of a food-grad silicone rubber showing a resiliency and forming a through hole 21. When the closure member 50 is driven by the weight of the flow control assembly 40 to move downward and sit on the through hole 21, a secure seal is formed therebetween due to the downward pressure. The receptacle 10 forms therein a plurality of positioning sections 12 that engages and retains the filtering member 30 in position. The receptacle 10 forms at an outer surface thereof a handle 13 for easy hand holding. The bottom of the receptacle 10 has an underside forming a plurality of downward-extending guide posts 14 for positioning and supporting the flow control assembly 40. Each of the guide posts 14 has an expanded end 141 and forms a plurality of vertically extending slits 142, so as to make the guide post 14 elastically deformable with a portion thereof The receptacle 10 has a lower rim forming a plurality of coupling holes 15, and a hood 16 forms a plurality of coupling projections 161 corresponding to the coupling holes 15. The coupling projections 161 may engage the coupling holes 15 to attach the hood 16 to the lower rim of the receptacle 10. The hood 16 has a diameter that is greater than the flow control assembly 40 that is arranged below the bottom of the receptacle 10 so as to accommodate the flow control assembly 40 inside the hood 16 to prevent undesired contact with the flow control assembly 40 by a user. Further, the hood 16 forms a plurality of cutoffs 162. The receptacle 10 comprises a resilient ring 17 made of a resilient plastic or rubber material and fit over the outer surface of the receptacle 10.

The filtering member 30 is embodied in the form of a filter screen in the instant embodiment having a circumferential wall tightly fit to an inside surface of the receptacle 10. The circumferential wall of the filtering member 30 engages the positioning sections 12 and is thus fixed, but allows of easy removal and realizing the function of filtering off the substance to be brewed and other contaminants contained in the brewing liquid. The filtering member 30 forms an upward projecting cylinder 31 through which an air passage 32 is defined.

The flow control assembly 40 forms a plurality of through apertures 41 corresponding to the guide posts 14. The through apertures 41 has an inside diameter that is greater than the guide posts 14 but is smaller than the expanded ends 141 of the guide posts 14, whereby when the receptacle 10 and the flow control assembly 40 are coupled, due to the elasticity of the guide posts 14, the expanded ends 141 are forced to deform for passing through the through apertures 41 and then resuming the shape to engage a surface of the flow control assembly 40 circumferentially around the through apertures 41. Thus, the guide posts 14 are movably received through the through apertures 41 to allow of efficient and ready coupling of thee flow control assembly 40 to the bottom of the receptacle 10 without undesired separation and also making the flow control assembly 40 movable through a predetermined stroke in a stable and un-shaking manner when the receptacle 10 is switched between liquid discharged condition and liquid blocked condition to thereby ensuring smooth dispensing of the liquid and effective block leak of the liquid. The flow control assembly 40 forms a flow guide section 42 that forms a through bore. A frame 43 that is structured to allow liquid to pass therethrough is arranged inside the flow guide section 42. The frame 43 carries a bar 44 that penetrates through the through hole 21 of the bearing member 20 (as well as the bore 11). The bar 44 has a free end coupled to the closure member 50 that selectively blocks the through hole 21. An upward movement of the bar 44 pushes the closure member 50 away from a position engaging the through hole 21 of the bearing member 20, thereby releasing a blocked condition of the through hole 21 (as well as the bore 11).

The chassis 60 comprises a retention frame 61. The receptacle 10 is structured in such a way that the outer surface thereof shows a converging configuration having an expanded upper end and a reduced lower end, so that the receptacle 10 is receivable in and retained in position by the retention frame 61. The retention is realized through the resilient ring 17 for elimination of undesired gaps and shocks induced therebetween, whereby the receptacle 10 can be securely supported on the chassis 60 but can be easily removed out of the chassis 60.

The receptacle 10 form a tubular guidance section 18 surrounding and extending from a lower end of the bore 11. The flow guide section 42 of the flow control assembly 40 corresponds in position to the guidance section 18, and the guidance section 18 is sized to partially fit into the flow guide section 42, whereby the guidance section 18 and the flow guide section 42 collectively define a water passage.

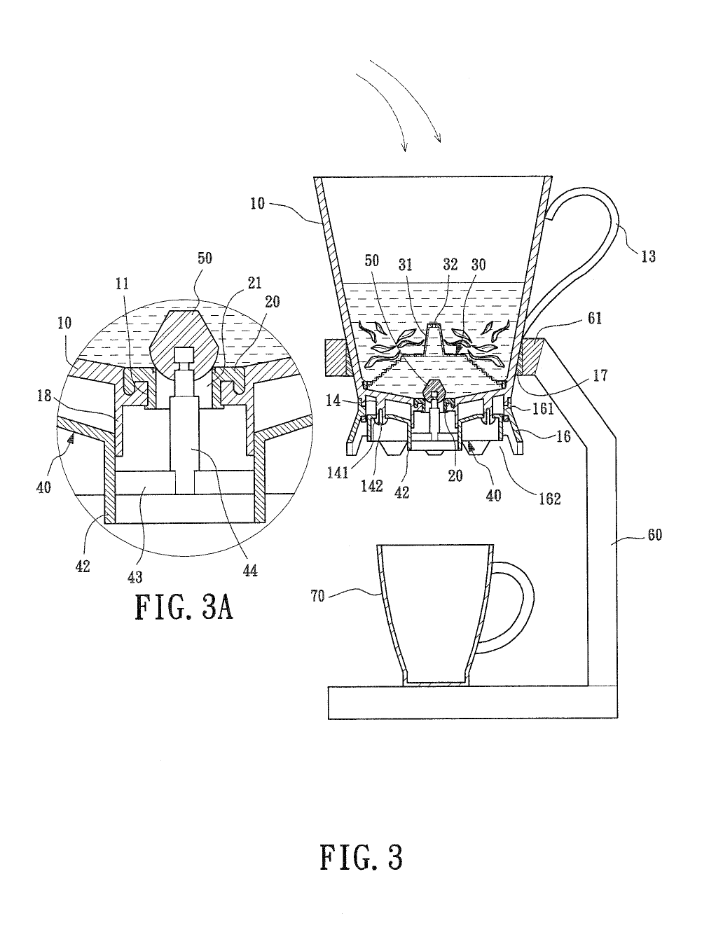

Referring to FIGS. 3 and 3A, to use the present invention, a substance to be brewed is positioned in the receptacle 10 and a brewing liquid is also poured into the receptacle. Due to gravitation, the flow control assembly 40 naturally moves downward to cause the closure member 50 to sit on the through hole 21 of the bearing member 20 (the bore 11). The closure member 50 has an outside diameter that is greater than inside diameter of the through hole 21 so as to block the through hole 21. This prevents the brewing liquid contained in the receptacle 10 from flowing outward and flow stopping is realized to allow the substance to be brewed inside the receptacle 10.

It is noted here that since according to the present invention, the chassis 60 is structure to securely hold the receptacle 10 thereon, a user may place the receptacle 10 firmly on the chassis 60 and maintaining a desired height, so that the user's hand does not need to keep holding the receptacle 10. The chassis 60 is also structured to receive and support a container 70 at a location corresponding to the flow guide section 42 of the flow control assembly 40 for receiving and containing the brewing liquid draining from the receptacle 10 for later drinking.

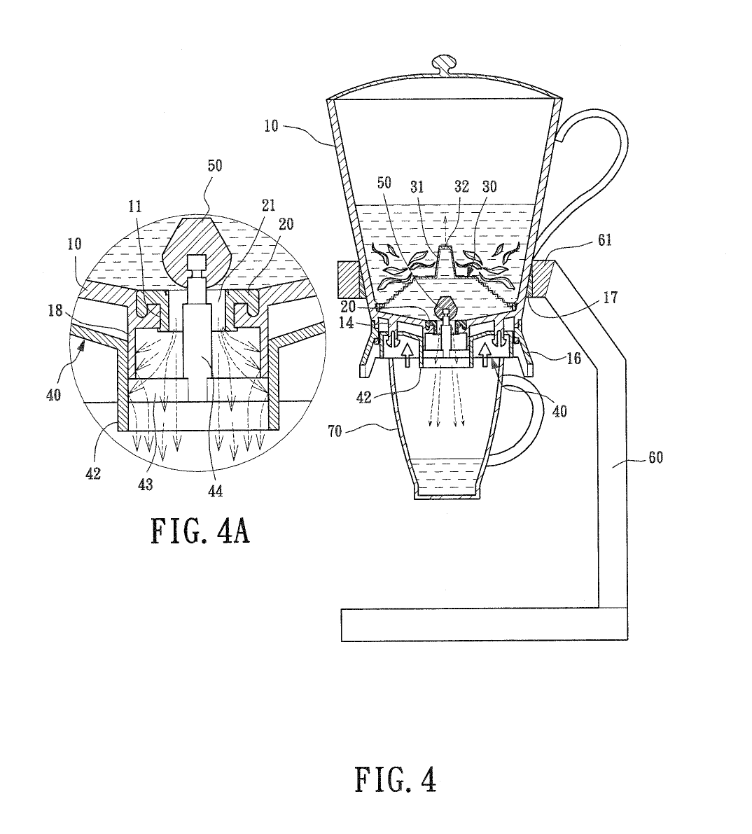

Referring to FIGS. 4 and 4A, when the substance to be brewed has been brewed in the receptacle 10 for a predetermined period of time (in other words, the user being allowed to control the brewing concentration), the container 70 is moved upward to have a rim thereof contacting a lower side of the flow control assembly 40, whereby the container 70 pushes upward the flow control assembly 40, causing an upward movement of the flow control assembly 40 that makes the bar 44 driving the closure member 50 away from the through hole 21 of the bearing member 20. The brewing liquid contained in the receptacle 10 is thus allowed to flow through the through hole 21, the guidance section 18, and the flow guide section 42 to be dispensed into the container 70 for later drinking.

It is noted here that when the brewing liquid is discharged through the through hole 21, the air passage 32 formed in the cylinder 31 of the filtering member 30 provides a counter flow of air that improves smoothness of discharging the brewing liquid. Further, since the cylinder 31 is of a substantial height that allows of hand griping, when the filtering member 30 is broken or needs cleaning, the filtering member 30 can be readily removed for disassembling.

It is also noted that the water passage constituted by the guidance section 18 and the flow guide section 42 together is a tubular passage, which provides functions of both shielding and flow guiding. When the brewing liquid contained in the receptacle 10 is discharged through the through hole 21(the bore 11), the brewing liquid is shielded by the water passage and is confined and concentrated therein for smooth flow, whereby leak, splash, and overflow of the liquid are prevented.

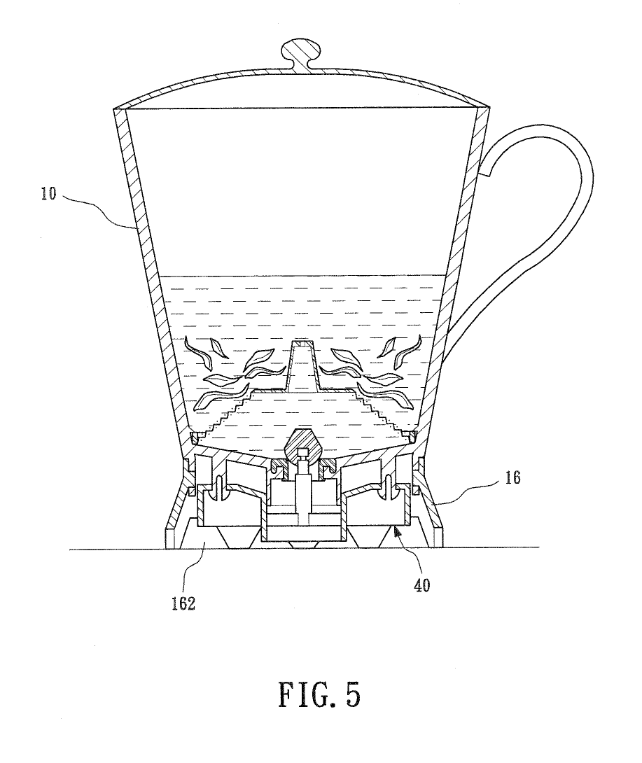

Referring to FIG. 5, the hood 16 arranged below the receptacle 10 provides covering and protection for the flow control assembly 40, so that a user may readily remove the receptacle 10 from the chassis 60 and place the receptacle 10 on a table top by having the hood 16 standing on the table top.

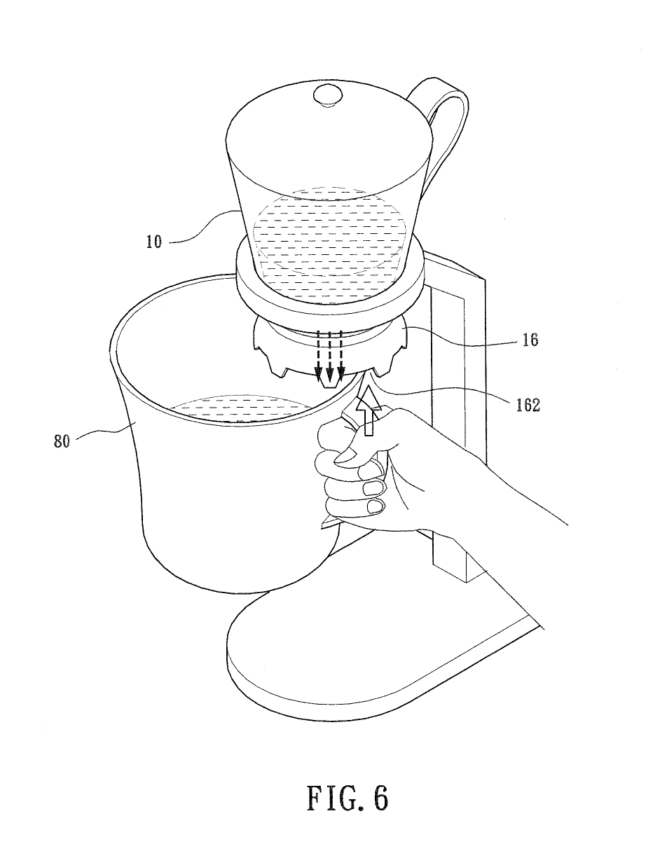

Referring to FIG. 6, when a container 80 that has an outside diameter greater than the flow control assembly 40 is used, a portion of an upper rim of the container 80 may be moved to locate within one of the cutoffs 162 of the hood 16, whereby the portion of the upper rim of the container 80 may push upward the flow control assembly 40, causing an upward movement of the flow control assembly 40 to thereby discharge the brewing liquid contained in the receptacle 10 into the container 80.

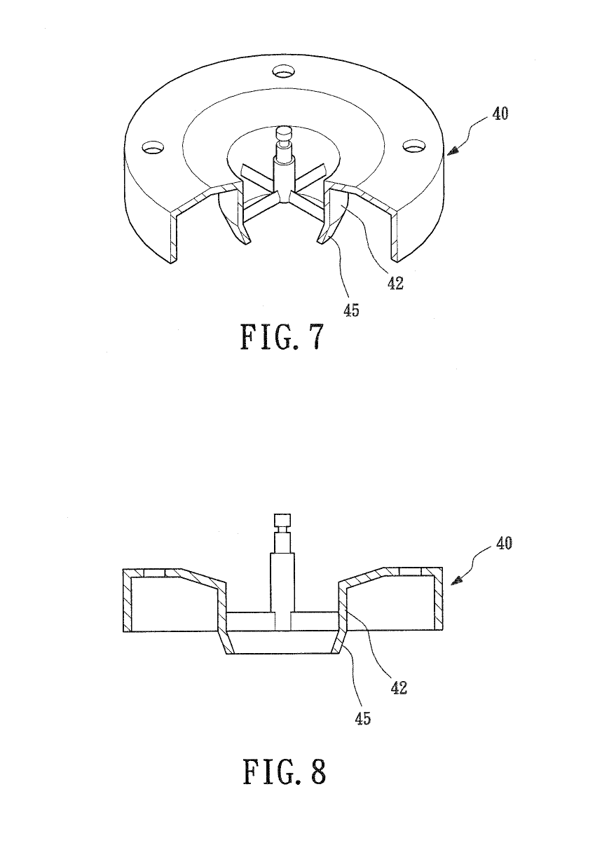

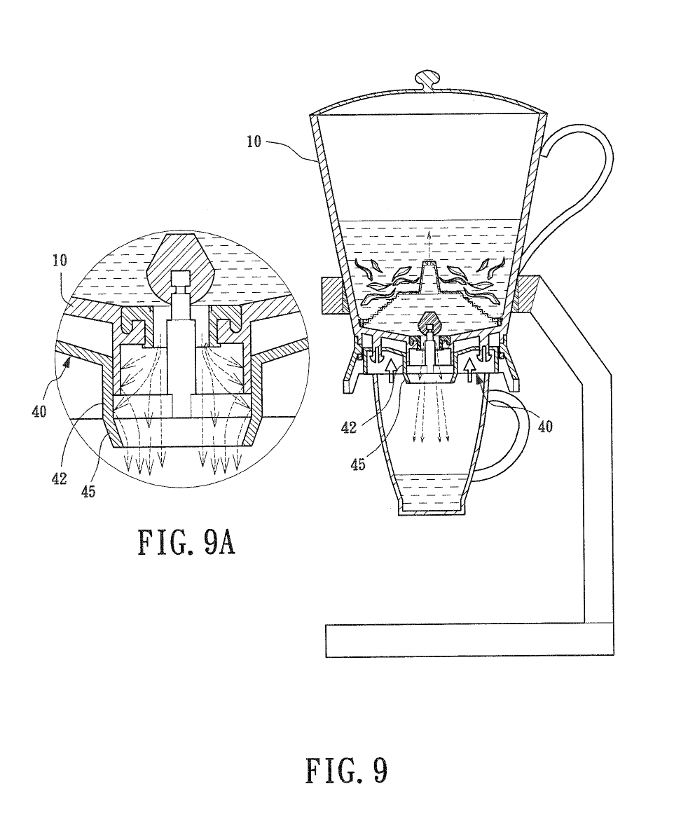

Referring to FIGS. 7, 8, 9 and 9A, another embodiment of the flow control assembly 40 according to the present invention is shown, wherein the flow guide section 42 has a lower section that forms a converging section 45, whereby when brewing liquid is discharged through the flow guide section 42, further concentration of the liquid flow can be realized before the liquid is dispensed.

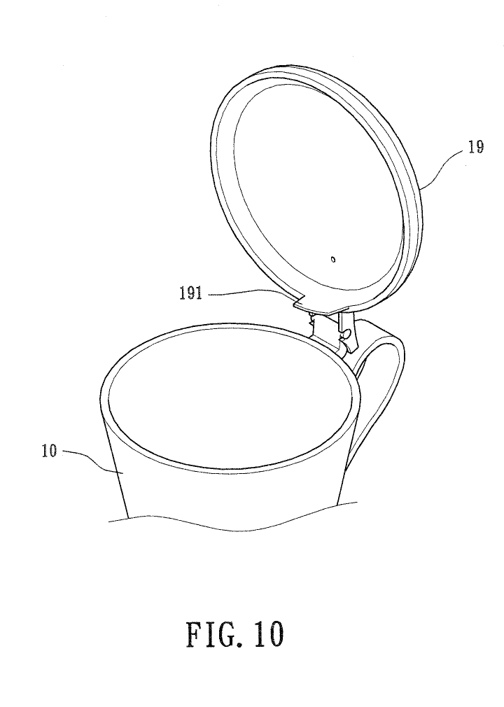

Referring to FIG. 10, according to the present invention, the receptacle 10 is provided at one side thereof a pivotally connected movable lid 19. The lid 19 may form in a liquid guide tab 191. The lid 19 is used to removably close an opening of the receptacle 10 for sanitation purposes. When a user lifts the lid 19, liquid droplets that are formed by condensation of steam of the brewing liquid of the receptacle 10 on an inside surface of the lid 19 may move along the liquid guide tab 191 to get back to the receptacle 10 without causing undesired splash and provides the efficacy of sanitation and cleanness.

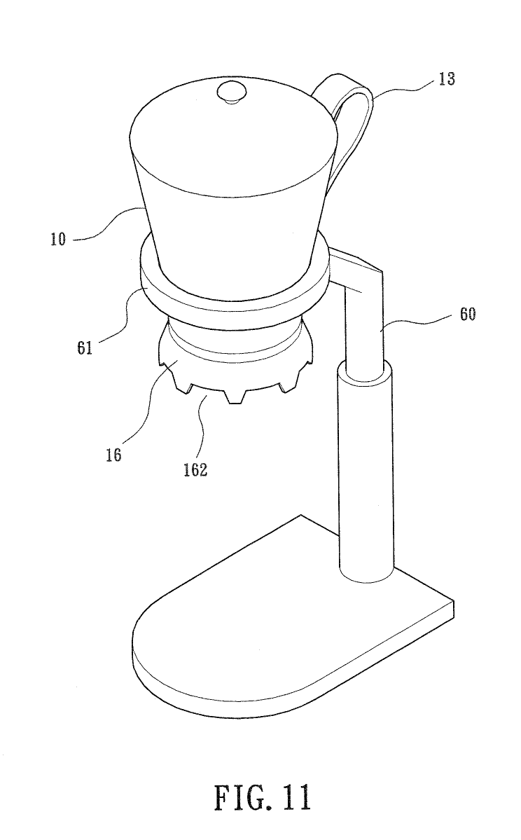

Referring to FIG. 11, according to another embodiment of the present inventing, the chassis 60 may be made in a telescopic or extendible structure to form an extendible frame structure for easy adjustment of the height thereof.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A brewing device comprising:
a receptacle, which has a bottom forming a bore;
a filtering member, which is arranged inside the receptacle; and
a flow control assembly, which is arranged below the receptacle and is vertically movable with respect to the receptacle, the flow control assembly comprising a bar that is extendable through the bore, the flow control assembly being movable upward to drive away a closure member sitting on the bore;
wherein a guidance section is formed below the bore, the flow control assembly forming a flow guide section corresponding to the guidance section, whereby when the flow control assembly is moved upward, the guidance section and the flow guide section collectively form a water passage so that a brewing liquid contained in the receptacle, when discharged through the bore, is effectively shielded by the water passage and is confined and concentrated for smooth flow so as to eliminate occurrence of leak, splash, and overflow of the liquid.

2. The brewing device according to claim 1, wherein a resilient bearing member is received and retained in the bore, the bearing member forming a through hole, which is selectively blocked by the closure member to a form a tight sealing engagement therebetween.

3. The brewing device according to claim 1, wherein the receptacle forms therein a plurality of positioning sections for engaging and retaining the filtering member.

4. The brewing device according to claim 1, wherein the receptacle has an outer surface forming a handle.

5. The brewing device according to claim 1, wherein the receptacle has an underside forming a plurality of downward-extending guide posts, each of which has an expanded end and forms a plurality of vertically extending slits, the flow control assembly forming a plurality of through apertures corresponding to the guide posts whereby the ends of the guide posts are elastically deformable to pass through the through apertures and the resuming to engage the flow control assembly in such a way that the flow control assembly is vertically movable.

6. The brewing device according to claim 1, wherein the receptacle forms a plurality of the coupling holes and a hood forms coupling projections corresponding to the coupling holes, the coupling projections being engageable with the coupling holes to attach the hood to the receptacle for shielding and protecting the flow control assembly

7. The brewing device according to claim 6, wherein the hood forms a plurality of cutoffs.

8. The brewing device according to claim 1, wherein the receptacle comprises an outer surface over which a resilient ring is fit.

9. The brewing device according to claim 1, wherein the filtering member comprises a projecting cylinder through which an air passage is formed.

10. The brewing device according to claim 1, wherein the receptacle is positionable on a chassis, the chassis forming a retention frame that receives the receptacle to fit therein.

11. The brewing device according to claim 10, wherein the chassis comprises an extendible structure to form an extendible frame for adjustment of height thereof.

12. The brewing device according to claim 1, wherein the receptacle comprises a movable lid pivotally attached to one side thereof, the lid forming a liquid guide tab.
